(19) United States
(12) Patent Application Publication
(10) Pub. No.: US 2026/0038365 A1
(43) Pub. Date: Feb. 5, 2026

(54) SYSTEM AND METHOD FOR DETERMINING CRITICAL LINK SEGMENTS IN A GEOGRAPHICAL AREA

(71) Applicant: HERE Global B.V., Eindhoven (NL)

(72) Inventor: James Adeyemi FOWE, Chicago, IL (US)

(21) Appl. No.: 18/790,939

(22) Filed: Jul. 31, 2024

(51) Int. Cl. G08G 1/01; G08G 1/0968

(52) U.S. Cl. CPC G08G 1/0133; G08G 1/0129; G08G 1/0145; G08G 1/096805

(57) ABSTRACT

A system for determining critical edges is provided. The system obtains an OD matrix of a predefined time period indicating traffic volume values for OD pairs in a geographical area, identifies OD pairs of the OD pairs having traffic volume values greater than a traffic threshold, and generates a network graph for the predefined time period based on the identified OD pairs. The network graph comprises nodes associated with a plurality of locations within the geographical area, and edges associated with weight values indicative of a trip volume. The system determines critical edges for the predefined time period based on the weight values of the edges, and stores edge data associated with the critical edges for the predefined time period in a map database.

### TECHNOLOGICAL FIELD

The present disclosure relates generally to an intelligent transportation system, and more specifically relates to systems and methods to determine link segments having heavy traffic volume.

### BACKGROUND

Traffic congestion, specifically, in urban areas and mega cities, is driven by improper road infrastructure, urbanization, population growth, ongoing construction activities, and exponential increase in number of vehicles. In addition, people may have to travel farther distances regularly, such as to commute to their offices, businesses, and/or other activity spots. Typically, residential areas and working areas (such as offices and businesses) are geographically distant from each other requiring people to travel long distances invariably leading to or worsening traffic congestion.

In recent years, urban traffic congestion has become increasingly pronounced and severe, causing long hours of traffic congestion, and leading to wastage of time. Further, traffic congestion contributes to a deterioration in the overall quality of life of commuters as it leads to longer travel times, higher fuel consumption, less personal time, and increased vehicular crash rates, all of which. Additionally, congestion results in lower vehicle speeds, longer journey times, and unreliable arrival timings, causing frustration and stress for people. The socioeconomical impact of congestion may also be quantified in terms of the cost of time wasted in the traffic, fuel consumed, and CO₂ emissions produced, which can have a substantial financial burden and environmental burden on the urban areas and the mega cities. Furthermore, traffic congestion affects daily routines and lifestyle, leading to an inferior quality of community life. Overall, traffic congestion negatively affects people's well-being, productivity, and overall satisfaction with their living environment.

The widespread utilization of navigation applications for digital navigation provides route guidance by considering traffic conditions. For example, the navigation applications may use satellite navigation system (such as global positioning system (GPS), satnav, etc.) for spatial positioning to a high precision, as well as to infer vehicle speeds and hence occurrence and/or location of traffic congestion. However, the conventional navigation applications work on user-level. In other words, the navigation applications are typically optimized to keep an individual driver's travel time as short as possible, without considering city-wide traffic surge problems and trip demands.

Therefore, there is a need for improving navigation applications to address the above-mentioned challenges and offering an efficient approach for city-wide transportation planning, and traffic management to mitigate traffic congestion, improve travel quality, and promote sustainable urban development.

### BRIEF SUMMARY

The present disclosure provides a system, a method, and a computer programmable product for determining critical link segments with heavy traffic flow in a transportation network for optimizing smart city mobility.

In one aspect, a system for determining critical link segments in a geographical area is provided. The system may comprise a memory configured to store computer executable instructions. The system may comprise one or more processors configured to obtain an origin-destination (OD) matrix of a predefined time period indicating a plurality of traffic volume values for a plurality of OD pairs in a geographical area. The one or more processors are configured to identify one or more OD pairs of the plurality of OD pairs having traffic volume values greater than a traffic threshold. Further, the one or more processors are configured to generate a network graph for the predefined time period based on the identified one or more OD pairs. The network graph comprises a plurality of nodes and a plurality of edges, the plurality of nodes is associated with a plurality of locations within the geographical area, and each of the plurality of edges is associated with a weight value indicative a trip volume. The one or more processors are configured to determine one or more critical edges of the plurality of edges for the predefined time period based on the weight value of each of the plurality of edges. Further, the one or more processors are configured to store edge data associated with the one or more critical edges for the predefined time period in a map database.

In additional system embodiments, each of the plurality of edges indicates a travel path between a corresponding pair of nodes from the plurality of nodes, and the one or more critical edges correspond to one or more travel paths having the weight value greater than a weight threshold during the predefined time period.

In additional system embodiments, the one or more processors are further configured to determine an average travel time for each of the one or more travel paths associated with the plurality of edges for the predefined time period and store the average travel time in association with the corresponding weight value for each of the plurality of edges.

In additional system embodiments, the one or more processors are further configured to determine a plurality of subset matrices for a plurality of time instants within the predefined time period based on the OD matrix and generate a plurality of network graphs for each of the plurality of time instants based on the corresponding plurality of subset matrices. Each of the plurality of network graphs comprise the plurality of nodes and one or more edges, and each of the one or more edges have an associated weight indicative of a time instant trip volume. The one or more processors are further configured to generate the network graph for the predefined time period based on an aggregation of the plurality of network graphs for each of the plurality of time instants.

In additional system embodiments, the one or more processors are further configured to execute the instruction to generate a tree graph for the predefined time period based on the plurality of nodes and an inverse of the weight value of each of the plurality of edges and determine the one or more critical edges of the plurality of edges for the predefined time period based on the tree graph.

In additional system embodiments, the one or more processors are configured to generate a plurality of historical network graphs. Each of the plurality of historical network graphs correspond to historical periods of time associated with the predefined time period. Further, the one or more processors are configured to generate a plurality of historical tree graphs corresponding to each of the plurality of historical network graphs. Further, the one or more processors are configured to compare the tree graph and the plurality of historical tree graphs to determine a stability score and generate a trip flow pattern graph for the geographical area based on the tree graph and the plurality of historical tree graphs on ascertaining the stability score to be greater than a stability threshold.

In additional system embodiments, the tree graph is a minimum spanning tree graph.

In additional system embodiments, the one or more processors are configured to generate navigation instructions for a vehicle associated with the geographical area based on the one or more critical edges for the predefined time period.

In additional system embodiments, the one or more processors are configured to receive a source location and a destination location associated with navigation of the vehicle and identify a pair of nodes from the plurality of nodes of the network graph corresponding to the source location and the destination location. Further, the one or more processors are configured to determine whether at least one edge between the pair of nodes includes one of the one or more critical edges. Further, the one or more processors are configured to generate the navigation instructions based on the determination. The navigation instructions include an alternative edge for one of the one or more critical edges in the at least one edge.

In additional system embodiments, the network graph is a maximum trip flow graph (MTFG).

In another aspect, a method for determining critical link segments in a geographical area is provided. The method comprises obtaining an origin-destination (OD) matrix of a predefined time period indicating a plurality of traffic volume values for a plurality of OD pairs in a geographical area. The method further comprises identifying one or more OD pairs of the plurality of OD pairs having traffic volume values greater than a traffic threshold and generating a network graph for the predefined time period based on the identified one or more OD pairs. In an example, the network graph comprises a plurality of nodes and a plurality of edges. The plurality of nodes is associated with a plurality of locations within the geographical area, and each of the plurality of edges is associated with a weight value indicative a trip volume. The method further comprises determining one or more critical edges of the plurality of edges for the predefined time period based on the weight value of each of the plurality of edges. The method further comprises storing edge data associated with the one or more critical edges for the predefined time period in a map database.

In yet another aspect, a computer programmable product for determining the critical edges is disclosed. The computer programmable product comprises a non-transitory computer readable medium having stored thereon computer executable instructions, which when executed by one or more processors, cause the one or more processors to conduct operations. The operations comprise obtaining an origin-destination (OD) matrix of a predefined time period indicating a plurality of traffic volume values for a plurality of OD pairs in a geographical area. The operations further comprise identifying one or more OD pairs of the plurality of OD pairs having traffic volume values greater than a traffic threshold. The operations further comprise generating a network graph for the predefined time period based on the identified one or more OD pairs, the network graph comprising a plurality of nodes and a plurality of edges. The plurality of nodes is associated with a plurality of locations within the geographical area, and each of the plurality of edges is associated with a weight value indicative a trip volume. The operations further comprise determining one or more critical edges of the plurality of edges for the predefined time period based on the weight value of each of the plurality of edges. The operations further comprise storing edge data associated with the one or more critical edges for the predefined time period in a map database.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment in which a system for determining critical edges is implemented, in accordance with an embodiment of the disclosure;

FIG. 2 illustrates a block diagram of the system of FIG. 1, in accordance with an embodiment of the disclosure;

FIG. 3A illustrates an example OD matrix, in accordance with an example embodiment of the present disclosure;

FIG. 3B illustrates an example generalized OD matrix for determining critical edges, in accordance with an example embodiment of the present disclosure;

FIG. 4A illustrates a flowchart of a method for generating a network graph, in accordance with an example embodiment of the present disclosure;

FIG. 4B illustrate an example network graph for determining critical edges, in accordance with an example embodiment of the present disclosure;

FIG. 5 illustrates a flowchart of a method for generating navigation instructions, in accordance with an example embodiment of the present disclosure;

FIG. 6 illustrates a flowchart of a method for determining one or more critical edges in a geographical area, in accordance with an example embodiment of the present disclosure;

FIG. 7 illustrates an exemplary format of map data stored in a map database, in accordance with one or more example embodiments;

FIG. 8 illustrates another exemplary format of the map data stored in the map database, in accordance with one or more example embodiments; and

FIG. 9 illustrates an exemplary map database storing map data for determining the one or more critical edges in the form of attributes shown in FIG. 7 and FIG. 8, in accordance with one or more example embodiments.

### DETAILED DESCRIPTION

In order to solve the foregoing problem, the present disclosure may provide a system, a method, and a computer programmable product for analyzing road traffic data in an origin destination (OD) matrix to determine critical route(s) in a geographical area having heavy volume of traffic.

The embodiments of the present disclosure are based on an understanding that analysis of road traffic patterns in the origin destination (OD) matrix may be performed to ensure that a driver takes or travels on a most efficient route. In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

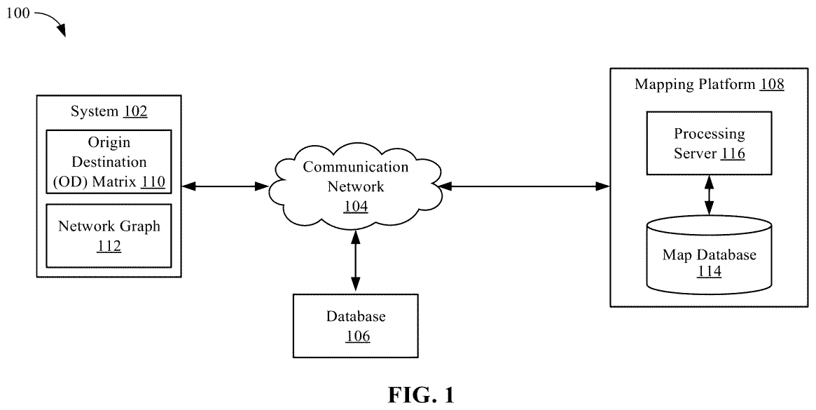

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 9, a brief description concerning the various components of the present disclosure will now be briefly discussed. Reference will be made to the figures showing various embodiments of a system for determining the critical edges.

### Definitions

The term “vehicle” may refer to an autonomous, semi-autonomous or manual automotive vehicle that may use one or more motors for propulsion on or above ground surface in an example, vehicle refers to any device or apparatus capable of transporting goods or passengers over land, water, or air. The vehicle may also extend to encompass various components, systems, and accessories associated with transportation devices, such as propulsion systems, control mechanisms, navigation systems, safety features, energy storage devices, and communication systems. A vehicle may encompass a wide range of transportation means, including but not limited to, land vehicles, aircraft, and watercraft. While the embodiments of the present disclosure are described with regard to the vehicle being a land vehicle, this should not be construed as a limitation. Implementation of the embodiments of the present disclosure to other types of vehicles may be apparent to a person skilled in the art.

The term “origin-destination (OD) matrix” may refer to a matrix that may indicate flow of trips between various origin and destination pairs within a given geographical area. The OD matrix may be a square matrix that quantifies volume of trips between all pairs of origins and destinations within a transportation network. In an example, each cell of the OD matrix may represent a number of trips or the flow of goods, people, or vehicles moving from an origin zone to a destination zone. For example, rows of the OD matrix may represent the origins, while columns of the OD matrix may represent the destinations. In navigation and transportation planning, OD matrices may be used to understand travel patterns, predict traffic flows, optimize route selection, guide infrastructure investments, and evaluate transportation policies.

In certain cases, the “route” may consist of a series of interconnected segments, such as roads, highways, streets, or pathways, each with its own geographic coordinates and attributes. These segments are selected based on criteria such as distance, travel time, traffic conditions, road quality, and user preferences. For example, the route may be generated by navigation systems or route planning algorithms, which may analyze geographic data, real-time traffic information, and user input to determine an optimal path for reaching a destination. The selected route may vary depending on factors such as mode of transportation, time of day, weather conditions, and specific user preferences or constraints.

The term “network graph” may refer to a model that maps connectivity between various locations within a transportation network. In an example, the network graph may be a mathematical representation of a transportation network consisting of a plurality of nodes and a plurality of edges. The plurality of nodes may represent specific locations or points of interest, such as intersections, landmarks, origins, or destinations. Moreover, the plurality of edges may represent connections or paths between these locations. In this manner, the network graphs are used to model road networks, public transit systems, or other transportation infrastructure.

The term “transportation networks” refers to roadways within a given area (e.g., city, town, county, etc.). Although various embodiments are described with respect to transportation networks, it is contemplated that the approach described herein may be used with other networks wherein sufficient data and a base map may be available such as pedestrian walkway networks (e.g., city, mall, amusement park, etc.), trains, maritime, etc. Additionally, it is contemplated that the approach described herein may be used with multiple overlapping networks such as, for example, roadways, train, and pedestrian networks or maritime, train and freight networks.

### End of Definitions

The present disclosure provides techniques for determining one or more critical link segments and/or routes in a geographical area having high traffic volume. As may be understood, the OD matrix encapsulates information regarding the flow of traffic between different origin and destination pairs within the specified geographical area over a defined time period. Despite its significance, the OD matrix is often underutilized, failing to leverage its potential to comprehend city-wide traffic patterns effectively. Understanding these traffic patterns is paramount as it provides crucial insights into congestion hotspots, travel demand, and the utilization of transportation infrastructure across the city.

In the realm of transportation network management, comprehending city-wide traffic patterns holds immense importance. By analyzing these patterns, transportation authorities can identify critical link segments and/or routes and nodes within the transportation network. This understanding enables the optimization of traffic flow, minimization of congestion, and enhancement of overall transportation efficiency. Moreover, insights gleaned from city-wide traffic patterns can enable decision-makers to take informed strategic decisions related to transportation infrastructure development, urban planning initiatives, and traffic management strategies.

The embodiments of the present disclosure are based on a recognition that identifying critical link segments and/or routes within cities may significantly contribute to improving traffic flow and enhancing the efficiency of transportation networks. These critical link segments and/or routes, once identified, can be strategically managed to mitigate congestion, reduce travel times, and enhance overall urban mobility. Additionally, this knowledge can be leveraged for city development planning, infrastructure investments, and urban design interventions aimed at fostering sustainable and resilient urban environments. Overall, the ability to identify and address critical link segments and/or routes represents a fundamental aspect of optimizing transportation networks and improving the quality of life for urban residents.

FIG. 1 illustrates a network environment 100 within which a system 102 for determining critical link segments and/or routes in a geographical area is implemented, in accordance with an embodiment of the disclosure. The network environment 100 may include the system 102, a communication network 104, a database 106 and the mapping platform 108. Further, the system 102 is configured to obtain an OD matrix 110 for analyzing traffic patterns and generating and store a network graph 112 based on the OD matrix 110.

The system 102 may be a highly specialized system that may integrate a hardware and a software. The system 102 may be equipped with a high-speed network interface, a multi-core processor, and a memory, the hardware configuration may support real-time image processing and analysis. The custom software may orchestrate the communication network 104 monitoring process. The system 102 may be optimized for live interaction with high-speed networks.

In operation, the system 102 is configured to obtain the origin-destination (OD) matrix 110 of a predefined time period indicating a plurality of traffic volume values for a plurality of OD pairs in a geographical area. In an example, the OD matrix 110 is a matrix database used as a tool in transportation planning and analysis. The OD matrix 110 may include plurality of traffic volume values that may indicate trip volume or flow of traffic between a plurality of pairs of origin locations or zones and destination locations or zones within the geographical area over a predefined time period. The traffic volume values in the OD matrix 110 represent the magnitude of travel demand between various pairs of origin and destination location or zones within the geographical area during the predefined time period.

The traffic volume values may indicate a number of trips or vehicles traveling from an origin to a destination in the corresponding OD pair, providing quantitative insights into the flow of traffic between the origin and the destination in the geographical area. The geographical area may correspond to a city, metropolitan area, or any other defined urban or suburban region, and the predefined time period may refer to a specified time duration during a time of a day or a time of a week. The predefined time period may vary based on the scope and objectives of the analysis, ranging from hours to days, weeks, months, or even years. The OD matrix 110 represents the volume of travel demand between various pairs of origin and destination.

In an example, the OD matrix 110 is obtained from a database 106. Data collection methods such as traffic surveys, GPS tracking, mobile device data, or automatic vehicle counters may be utilized to populate the OD matrix 110 with the traffic volume values. These data sources capture information about the origin and destination points of individual trips, which is then aggregated to construct the OD matrix. Advanced techniques, including machine learning algorithms and data fusion methods, may also be employed to enhance the accuracy and granularity of OD matrix generation, thereby enabling more precise transportation planning and management.

Further, the system 102 is configured to identify one or more OD pairs of the plurality of OD pairs having traffic volume values greater than a traffic threshold. In an example, the geographical area may include various zones or areas, each representing either an origin or a destination. The OD matrix 110 comprises a plurality of OD pairs, where each OD pair represents a combination of an origin zone and a destination zone within the geographical area. For instance, an OD pair could be “Zone A to Zone B,” indicating trips originating from Zone A and destined for Zone B.

Further, the system 102 is configured to identify the one or more OD pairs of the plurality of OD pairs having traffic volume values greater than the traffic threshold. In this regard, the system 102 is configured to analyze the traffic volume values associated with each OD pair. This involves quantifying the number of trips between each origin-destination combination within the predefined time period. Further, the system 102 is configured to identify one or more OD pairs where the traffic volume values exceed the traffic threshold, indicating significant travel demand between corresponding origin(s) and destination(s).

Further, the system 102 is configured to generate a network graph 112 for the predefined time period based on the identified one or more OD pairs. In an example, the network graph 112 may be a mathematical representation of the transportation infrastructure within the geographical area. The network graph 112 comprises a plurality of nodes and a plurality of edges. The nodes represent a plurality of locations within the geographical area, such as intersections, neighborhoods, or landmarks or point of interest. Each node corresponds to an origin or destination location, or zone identified from the OD pairs. For example, if the OD pairs indicate trips between zone A and zone B, then there will be corresponding nodes representing these zones A and B in the network graph 112.

Furthermore, the edges are connections between two nodes and represent a travel path between the corresponding two nodes. The edges are established based on the identified OD pairs, indicating the existence of travel paths between the associated origin-destination locations or zones. Furthermore, each of the edges may have an assigned a weight value that indicates a trip volume along that particular travel path during the predefined time period. The weight value for an edge may indicate a number of trips between the two nodes, i.e., an origin location or zone and a destination location or zone, connected by the edge. Subsequently, the weight value of the edge may provide the information about traffic congestion on a travel path between the two locations indicated by two nodes in the network graph 112.

For instance, an edge may connect a node of a location or a zone A and a location or a node of zone B. If a traffic volume value between the node of the location or the zone A and the node of the location or the zone B in the OD matrix 110 is high, then one or more edges between two nodes corresponding to the location or the zone A and the location or the zone B may have high weight values indicating high trip volume. Once constructed, the network graph 112 provides a visual and mathematical representation of the transportation network's structure, connectivity, and traffic.

Further, the system 102 is configured to determine one or more critical edges of the plurality of edges for the predefined time period based on the weight value of each of the plurality of edges. In an example, determining the one or more critical edges (referred to as critical edges, hereinafter) of the network graph 112 enables identifying travel paths, link segments and/or routes that experience significant congestion or high traffic volume during the predefined time period. The system 102 is configured to analyze the weight value associated with each of the edges of the network graph 112, which represent corresponding trip volume.

Specifically, the system 102 assesses the weight values of the plurality of edges within the network graph 112 generated based on the OD matrix 110. The system 102 compares these weight values against thresholds or identifies an edge having a weight value that exceeds a threshold. The edges are considered critical as it signify travel path, link segment or route where traffic congestion or demand exceeds acceptable levels, potentially leading to delays, inefficiencies, or even safety concerns.

In an embodiment, each of the plurality of edges indicates a travel path between a corresponding pair of nodes from the plurality of nodes. Subsequently, the critical edges are those edges that have a weight value greater than a weight threshold during the predefined time period. The critical edges may indicate travel paths having exceptionally high trip volume or traffic during the predefined time period. If the weight value of a particular edge exceeds the weight threshold, it indicates that the corresponding travel path experiences significant congestion or demand. Therefore, the system 102 identifies one or more critical edges as those edges with weight values surpassing the weight threshold, signifying travel paths that are particularly congested or heavily utilized during the specified time period.

Further, the system 102 is configured to store edge data associated with the one or more critical edges for the predefined time period in a map database 114. In an example, upon identifying the one or more critical edges within the transportation network, the system 102 is configured to store the edge data related to the identified critical edges in the map database 114. The stored edge data enables decision-making processes and implement targeted interventions aimed at mitigating congestion and improving traffic flow.

The stored edge data may include information, such as the location of the critical edges within the geographical area, the corresponding node, i.e., origin and destination locations or zones, the trip or traffic volume traversing along a link segment, a travel path or a route associated with the critical edges during the predefined time period, and any additional attributes relevant to the specific transportation context.

By centralizing this information in the map database 114, the system 102 facilitates easy access and retrieval of the stored edge data of the critical edges for analysis, visualization, and integration with other transportation planning tools and systems, such as navigation and routing systems.

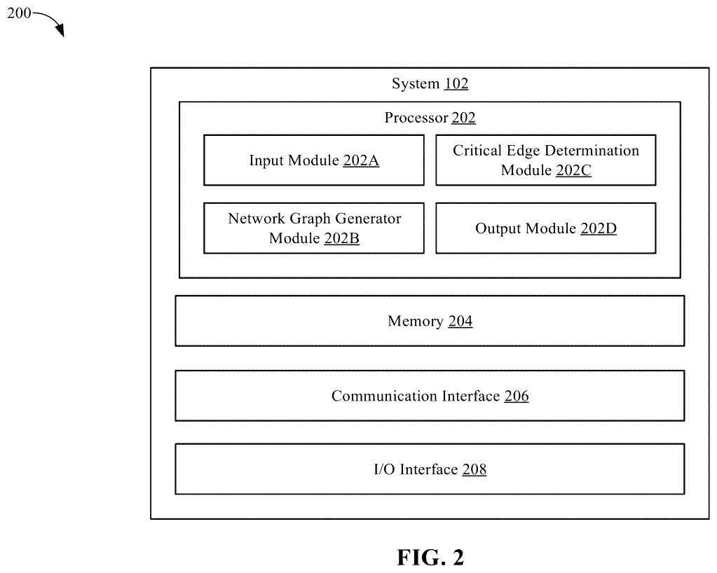

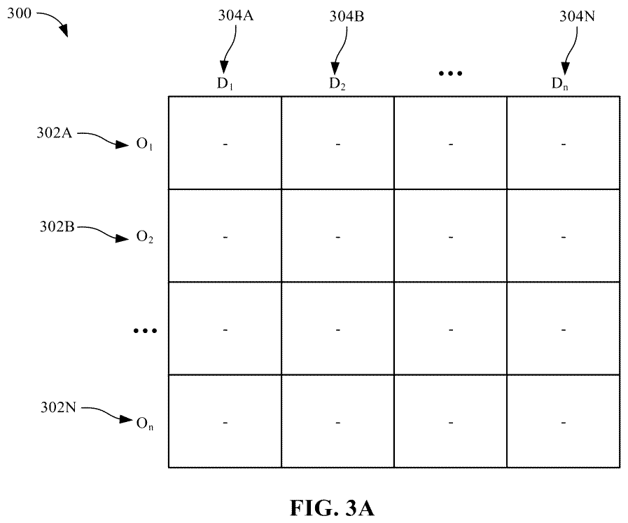

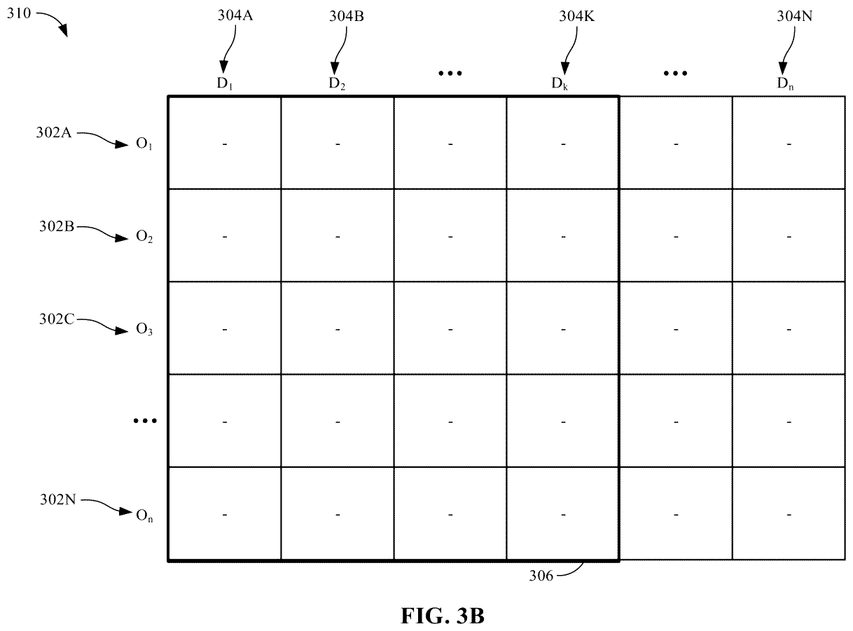

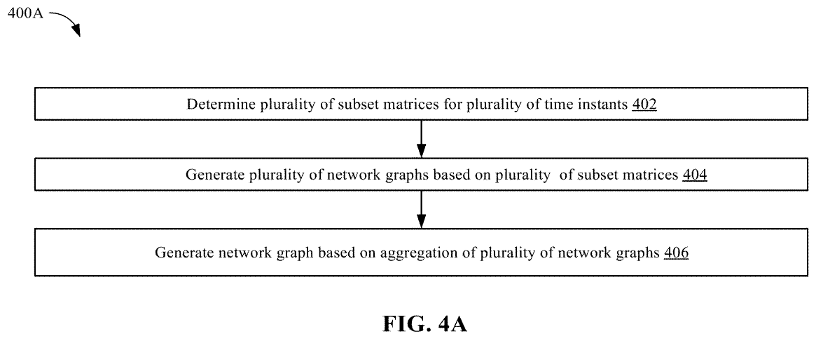

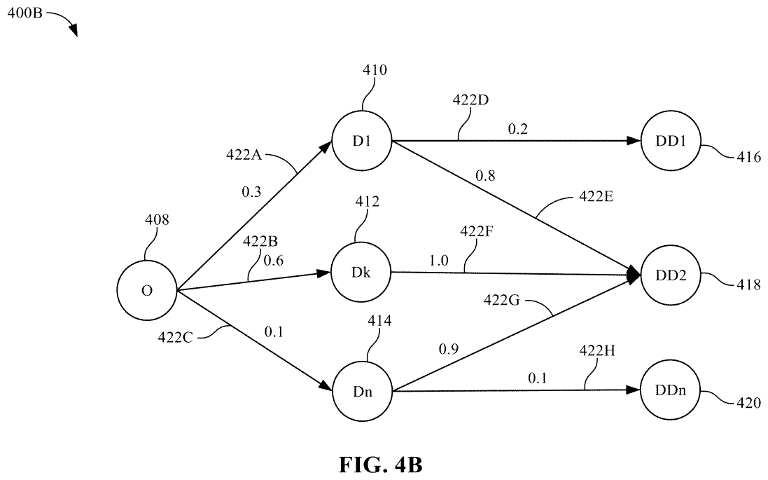

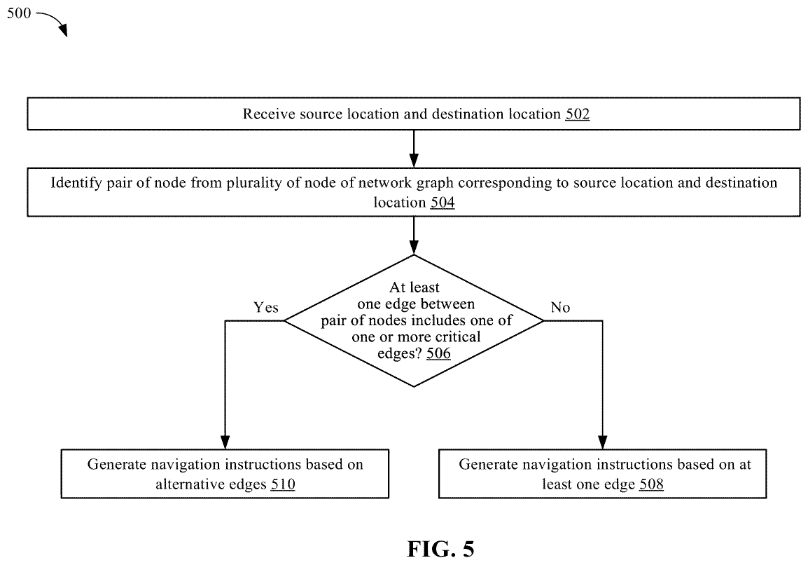

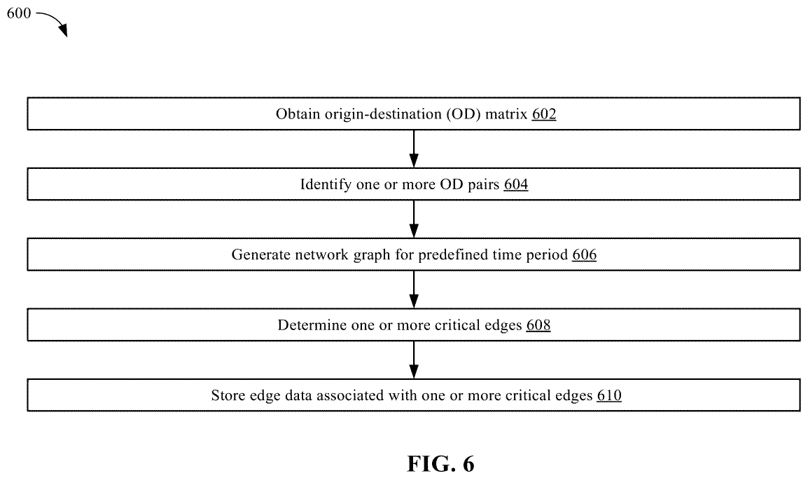

In some embodiments, the system 102 includes additional components for enabling the determination of critical routes. These components are further shown in conjunction with FIG. 2, FIG. 3A, FIG. 3B, FIG. 4A, FIG. 4B, FIG. 5 and FIG. 6.

FIG. 2 illustrates a block diagram 200 of the system 102 of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may be connected to the memory 204, the I/O interface 206, and the communication interface 208 through one or more wired or wireless connections. Although in FIG. 2, it is shown that the system 102 includes the processor 202, the memory 204, the I/O interface 206, and the communication interface 208, however, the disclosure may not be so limiting. The system 102 may include fewer or more components to perform the same or other functions of the system 102. Further the processor 202 may include an input module 202A, a network graph generator module 202B, a critical edge determination module 202C and an output module 202D.

The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network 104 may be accessed using the communication interface 208 of the system 102. The communication interface 208 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to conduct various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O interface 206 may communicate with the system 102 and display the input and/or output of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The communication interface 208 may include an input interface and an output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102 over the communication network 104. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to manage receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

The communication interface 208 of the system 102 may be used to access the communication network 104. The communication network 104 may include a communication medium through which the system 102 and, for example, the database 106 and the mapping platform 108, may communicate with each other. The communication network 104 may be one of a wired connection or a wireless connection. Examples of the communication network 104 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.115, IEEE 802.11g, multi-hop communication, wireless access point (AP), a device to device communication, cellular communication protocols, and Bluetooth (BT) communication protocols.

In one embodiment, the processor 202 may include the input module 202A. The input module 202A may be configured to receive, obtain, or retrieve input data. In an example, the input data may be received from, for example, the database 106, and/or other databases associated with the system 102, a user of the system 102, one or more sensors of vehicles, a navigation or delivery operation service provider, etc.

Pursuant to the present disclosure, the input data includes the OD matrix 110. The OD matrix 110 may include the traffic volume values associated with one or more OD pairs or a route between an origin and a destination. The traffic volume values may indicate historical traffic volume on each of the routes during the predefined period. Upon receiving the OD matrix 110, the input module 202A may be configured to validate and pre-process data of the OD matrix 110 to ensure its integrity and accuracy for subsequent analysis. The traffic volume values may indicate a traffic volume or a number of trips that happened on routes or link segments between each of the OD pairs during the predefined time period, for example, 9:00 AM to 9:30 AM of each of past days of a month or a number of months, say three months, or a number of years.

In one embodiment, the processor 202 may include a network graph generator module 202B. The network graph generator module 202B is configured to generate the network graph 112 based on the traffic volume values in the OD matrix 110. The network graph generator module 202B may operate by parsing the data of the OD matrix 110 and transforming it into a comprehensive visual representation of the transportation network.

In an example, a plurality of or multiple network graphs may be generated based on different time periods. For example, each of the network graphs corresponds to a predefined time period. In this manner, different network graphs may correspond to different time periods of the same day or the different days. In an example, the network graphs may be a directed acyclic graph (DAG), or a tree graph.

The network graph generator module 202B follows a systematic approach to generate the network graph 112. Firstly, the processor 202 identifies the nodes within the network graph 112, which represent specific locations or zones within the geographical area under analysis. Each node corresponds to a geographical location or a geographical zone in a geographical area. Subsequently, each node may be an origin location or zone, or a destination location or zone defined in the OD matrix 110.

Subsequently, the network graph generator module 202B establishes connections between two nodes i.e., origin and destination, using an edge and based on the data of the OD matrix 110. The edge represents a travel path or a route between the origin-destination pairs of the nodes identified in the OD matrix 110. The weight value associated with the edge typically denotes the trip volume or traffic data or other relevant metrics, facilitating a nuanced understanding of transportation patterns. By synthesizing this information, the network graph generator module 202B creates a comprehensive visualization of the transportation network.

In an example, the network graph 112 is generated for OD pairs having traffic volume values greater than a traffic threshold. In other words, OD pairs identified from the OD matrix having high traffic congestion are used to generate the network graph. In certain cases, each of the plurality of OD pairs from the OD matrix 110 may be represented in the network graph. Alternatively, in certain cases, only the OD pairs having traffic volume values greater than a traffic threshold may be represented in the network graph 112.

In an embodiment, the processor 202 or the network graph generator module 202B is configured to generate a tree graph for the predefined time period based on the plurality of nodes and an inverse of the weight value of the plurality of edges. The tree graph is generated using the plurality of nodes and the inverse of the weight value associated with each edge within the network graph 112. Edges with lower weight values in the network graph 112, may indicate higher traffic volume values or probabilities, and will have stronger influences in forming connections within the tree graph.

Further, the processor 202 is configured to determine one or more critical edges from the plurality of edges of the network graph 112 for the predefined time period based on the tree graph. By analyzing the structure and characteristics of the tree graph, which represents the network's topology and connectivity, the system 102 may pinpoint edges that play crucial roles in facilitating efficient traffic flow or that may be particularly prone to congestion or disruptions. This determination of critical edges enables transportation planners and authorities to prioritize interventions, optimize routing strategies, and mitigate potential bottlenecks within the transportation network, enhancing overall system efficiency and reliability.

In an embodiment, the tree graph is a minimum spanning tree graph. By constructing a minimum spanning tree, the system 102 ensures that the most efficient connections are established between nodes, optimizing overall network performance.

In an embodiment, the system 102 is configured to generate a plurality of historical network graphs. Each of the plurality of historical network graphs correspond to historical periods of time associated with the predefined time period. In an example, the predefined time period may correspond to 9:00 AM to 9:30 Am. Subsequently, the historical periods of time may correspond to 9:00 AM to 9:30 AM of a past day, (i.e., yesterday), or a number of past days in a past week, a past month, etc. These historical network graphs capture the transportation network's structure and dynamics during specific historical periods of time in the past. By generating a series of historical network graphs, the system enables comprehensive analysis of temporal variations in traffic patterns, route usage, and network performance over a period of time.

Further, the system 102 is configured to generate a plurality of historical tree graphs corresponding to each of the plurality of historical network graphs. These historical tree graphs represent simplified versions of the transportation network during specific historical periods, emphasizing essential connections and structures while minimizing redundancy and complexity. The historical tree graphs may be generated based on an inverse of the weight values of the edges in the historical network graphs. By generating historical tree graphs corresponding to historical network graphs, the system facilitates efficient analysis of temporal changes in network topology and critical routes over the period of time.

Further, the system 102 is configured to compare the tree graph and the plurality of historical tree graphs to determine a stability score. This comparison aims to assess the stability of the traffic pattern analyzed or determined for the transportation network over time by analyzing a magnitude of changes in weight values of the edges of the network graphs and/or tree graph(s) for the historical periods of time. Such magnitude of change in the weight values may be used to determine stability scores for the network graphs associated with the predefined time period. For example, if the magnitude of change of an edge over the historical time periods is small then stability score is high, whereas if a magnitude of change of the edge over the historical time periods is large then stability score is low. In an example, by evaluating deviations or changes in the weight values of an edges in a current graph and corresponding historical counterparts, a stability score for the edge is calculated.

In an example, a high stability score may indicate high stability of the edge. Therefore, the weight value of the edge in each of the historical network graphs and/or the historical tree graphs can be used to accurately predict an average trip volume or traffic congestion in a route associated with the edge. Alternatively, low stability score for an edge may indicate instability of the edge.

Once the processor 202 ascertains the stability score for one or more edges of the graph to be greater than a stability threshold, the processor 202 is configured to generate a trip flow pattern graph for the geographical area based on the tree graph and the plurality of historical tree graphs. The trip flow pattern graph visualizes the flow of trips within the tree graph of the transportation network, highlighting the critical edges, predominant routes, nodes, and connections through which traffic moves. By analyzing the structure of the tree graph as well as the plurality of historical tree graphs, which represents the network's topology and critical routes, the system 102 generates the trip flow pattern graph to provide a comprehensive overview of trip movements and traffic patterns within the geographical area.

Further, the system 102 is configured to generate the trip flow pattern graph based on the tree graph and the plurality of historical tree graphs on ascertaining the stability score of edges or a cumulative stability score of the tree graphs to be greater than a stability threshold. This functionality allows transportation planners and authorities to focus on periods characterized by sufficient network stability, facilitating more accurate analysis and decision-making regarding transportation infrastructure, traffic management, and long-term planning strategies.

In one embodiment, the processor 202 may include the critical edge determination module 202C. The critical edge determination module 202C is configured to identify critical edges indicative of critical or heavy traffic routes and/or link segments within the transportation network. In this regard, the critical edge determination module 20C analyzes the network graph 112 and/or the tree graph to determine the one or more critical edges during the predefined time period having the corresponding weight value greater than a weight threshold.

In an example, the critical edge determination module 202C is configured to aggregating network graphs obtained from different time periods, effectively amalgamating them into a comprehensive representation of the transportation network over an aggregated time period. In this regard, the weight values of an edge across each of the network graphs may be aggregated to capture a cumulative weight of the edge. The cumulative weight of the edge may indicate cumulative trip volume, traffic flow or other relevant metrics for a travel path associated with the edge over the aggregated time period. In this manner, a cumulative weight of each of the edges in the network graph 112 may be determined.

In an example, the critical edge determination module 202C is further configured to generate a minimum spanning tree graph (MST) for the network graph 112 generated by the network graph generator module 202B. The minimum spanning tree is generated by taking an inverse of the weight value of each of the arcs or the edges. Moreover, the critical edge determination module 202C identifies the most critical arcs, edges or OD pairs within the transportation network based on the MST. The critical edges may represent major transportation corridors, key intersections, or other critical nodes with high traffic volume values within the transportation network.

In one embodiment, the processor 202 may include the output module 202D. The output module 202D may include a display unit. The output module 202D may be configured to display key insights derived from the transportation network analysis. The display unit serves as a visual interface for stakeholders to interact with and interpret the results of the analysis.

The display unit showcases two main components: the network graph 112 and the critical OD pairs, in certain cases in a superimposed manner. The network graph 112 provides a graphical representation of the transportation infrastructure within the geographical area, depicting locations as nodes and travel path between two nodes as edges. This visualization allows stakeholders to gain a holistic understanding of the network's structure and connectivity.

Additionally, the display unit highlights critical edges and/or OD pairs associated with the critical edged, identifying travel paths, link segments and/or routes with significant traffic volume values or congestion levels. This information enables stakeholders to prioritize interventions and address congestion hotspots effectively.

Furthermore, the output module 202D may facilitate storage of the generated network graph 112 as well as edge data of the identified critical edges as an artefact, allowing for regeneration over similar time ranges. By storing and regenerating the graph, stakeholders can track changes in the transportation network over time and identify long-term trends or patterns.

Moreover, the output module 202D may facilitate the storage of additional metrics, such as average travel times and edge costs, associated with each OD pair. This comprehensive dataset provides valuable insights into travel patterns, route efficiencies, and transportation network performance, aiding in informed decision-making and strategic planning efforts.

In an embodiment, the processor 202, such as a routing module (not shown) of the processor 202 is configured to generate navigation instructions for a vehicle associated with the geographical area based on the one or more critical edges for the predefined time period. In an example, the critical edges for the predefined time period may be fed to the routing module. The routing module may be configured to generate user readable or user-understandable navigation instructions, such as routing messages, notifications, warning messages, etc., to provide navigation recommendation based on the critical edges. The routing module may send or push the routing messages to user equipment, such as user equipment on-board a vehicle to enable a user or a driver of the vehicle to travel based on the navigation instructions ensuring optimal travel time. The routing module may also send or push routing messages to other user equipment associated with the vehicle or other vehicles that may have to travel between an origin or source location and a destination location during the predefined time period.

By incorporating information about critical edges, the system 102 ensures that the navigation instructions guide vehicles along routes that avoid congested or problematic areas, optimizing travel efficiency and reliability.

In an embodiment, the processor 202 is configured to determine an average travel time for each of the t one or more ravel paths associated with the plurality of edges for the predefined time period. By analyzing historical data (i.e., the historical network graphs and/or the historical tree graphs) and real-time information (i.e., the network graph 112 and/or the corresponding tree graph), the processor 202 is configured to estimate a travel time for each of the different travel paths corresponding to the edges. The estimated travel time may indicate an approximate time duration required to traverse each travel path or a route (which may be a summation of one or more travel paths) within the transportation network. This information provides valuable insights into the expected travel times for various travel paths, link segments and/or routes, enabling more informed decision-making in navigation and route planning.

Further, the processor 202 is configured to store the average travel time for each of the plurality of edges in association with the corresponding weight value. This storage mechanism links the average travel time data with the specific edges' characteristics, such as traffic volume or probability distribution. By maintaining this association, the system 102 can efficiently retrieve and utilize the average travel time information during navigation and route planning processes.

FIG. 3A illustrates an example OD matrix 300 for determining a critical edge, in accordance with an example embodiment of the present disclosure. The OD matrix 300 may refer to a matrix that may indicate flow of trips between various origin and destination pairs within a given geographic area. The OD matrix 300 may be a square matrix that quantifies volume of trips between all pairs of origins (i.e., origin zones or origin locations) and destinations (i.e., destination zones or destination locations) within a transportation network.

In an example, each cell of the OD matrix 300 may represent a number of trips or the flow of goods, people, or vehicles moving from an origin to a destination. For example, rows (depicted as rows 302A, 302B, . . . , 302N) of the OD matrix 300 may represent the origins. As shown, a row 302A represents origin O₁, a row 302B represents origin O₂, and a row 302N represents origin O_{N}. Further, columns (depicted as columns 304A, 304B, . . . , 304N) of the OD matrix 300 may represent the destinations. As shown, a column 304A represents destination D₁, a column 304B represents destination D₂, and a column 304N represents destination D_{N}.

It may be noted, an intersection of a row and a column in the OD matrix 300 contains a traffic volume value for trips originating from the corresponding origin zone and destined for the respective destination zone. This traffic volume value indicates the number of trips between the origin zone and the destination zone. The number of trips may also indicate a magnitude of travel demand between the origin zone and the destination zone, serving as a quantitative measure of trip frequency or intensity.

For example, if an entry at the intersection of the row 302A and the column 304B shows a traffic volume value of 100, it signifies that there are 100 trips originating from the origin O₁ and destined for the destination D₂ within the predefined time period. Similarly, an entry at the intersection of the row 302B and column 304A indicates the traffic volume value for trips from the origin O₂ and destined for the destination D₁.

For example, the OD matrix 300 may also include historical traffic volume values corresponding to different time periods, such as 12:00 AM to 12:30 AM, . . . , 5:00 AM to 5:30 AM, 6:00 AM to 6:30 AM, 6:30 AM to 7:00 AM, . . . 12:30 PM to 1:00 PM, 1:00 PM to 1:30 PM, . . . , 11:30 PM to 12:00 AM for each of different days of week(s), month(s), and year(s) for each of the travel paths and/or routes within the geographical area. Further, the predefined time slots to be 30 minutes is only exemplary and should not be construed as a limitation. In other examples, the predefined time slots may be 1 minute, 5 minutes, 10 minutes, 15 minutes, 20 minutes, 45 minutes, 60 minutes, and the like.

In navigation and transportation planning, OD matrices may be used to understand travel patterns, predict traffic flows, optimize route selection, guide infrastructure investments, and evaluate transportation policies. Moreover, the OD matrix 300 plays a crucial role in scenario planning and risk management. During construction projects, large events, or extreme weather conditions, understanding how travel patterns may be affected is paramount. The OD matrix 300 allows stakeholders to anticipate changes in travel behavior, identify popular OD pairs that may be impacted, and assess the expected impact on traffic flow and congestion levels.

For instance, if a major sporting event is taking place in a certain part of the city, transportation planners can use the OD matrix 300 as well as the identification of the critical edges, i.e., the critical travel paths and/or routes, to identify the origin and destination zones that may get affected due to the sporting event. By analyzing the traffic volume values for each of the OD pairs, planners can anticipate increased demand for transportation services and implement measures to mitigate congestion and ensure smooth travel experiences for attendees.

Additionally, the ability to monitor OD trip flows enables various stakeholders, including state Departments of Transportation (DOTs), enterprise customers, and retailers, to leverage this data for strategic decision-making. For DOTs, understanding travel patterns and traffic flows is essential for optimizing transportation infrastructure, improving traffic management strategies, and enhancing overall mobility within the city.

For enterprise customers and retailers, insights derived from the OD matrix 300 may be used for location-based advertising strategies, demand forecasting models, and planning efforts. By understanding where and when travel demand is highest, businesses can tailor their services and operations to meet customer needs effectively and capitalize on emerging market trends.

FIG. 3B illustrates an example generalized OD matrix 310 for determining a critical edge, in accordance with an example embodiment of the present disclosure. The generalized OD matrix 310 is utilized in generating the network graph 112 from the OD matrix 300. In an example, the network graph 112 is a maximum trip flow graph (MTFG). As shown in the FIG. 3A, the OD matrix 300 is structured as an N by N (N×N) grid, where each cell represents the traffic volume value or trip count between a specific origin and destination zone pair.

The OD matrix 300 encompasses N number of origin locations or zones and N number of N number of destination locations or zones within the geographical area under analysis. For example, a subset of the OD matrix 300 is determined as the generalized OD matrix 310.

In an example, the generalized OD matrix 310 also include N number of origin locations or zones, i.e., a range of origins may be from O₁ to O_{N}. Further, the dimensionality of a number of destination locations or sones is reduced. In this regard, a subset 306 of K destinations from a total on N destinations is used to generate the generalized OD matrix 310.

In an example, the K destinations are chosen from the N destinations based on a number of trips to each of the N destinations during the predefined time period. For example, a number of destinations to which maximum number of trips from any of the origins O₁ to O_{N} is determined as K. In other words, K destinations may include the k number of top or most frequented destinations originating from various origins within the predefined time period, say between t1 and t2. A matrix of these K destinations with the N origins may form a subset 306 of the OD matrix 300 representing the most popular travel destinations within the geographical area during the predefined time period. For example, if a number of trips from an origin to a destination from the N destinations exceeds a predefined threshold value, then such origin-destination pair may be within the subset 306 and the destination may be within the K destinations. The subset 306 is referred to as the generalized OD matrix 310.

In an example, OD pairs in the generalized OD matrix 310 may signify routes or travel paths with high traffic volume values, indicating routes or travel paths experiencing elevated levels of trips or congestion. By identifying these critical OD pairs, transportation planners and authorities can prioritize interventions and implement measures to alleviate congestion and optimize traffic flow within the geographical area. Based on the generalized OD matrix 310, the one or more OD pairs having traffic volume values greater than a traffic threshold are identified.

In one embodiment, the system 102 is configured to generate the network graph 112 based on the generalized OD matrix 310, i.e., the one or more OD pairs having traffic volume values greater than the traffic threshold. Details of generating the network graph 112 is described in conjunction with, for example, FIG. 4A and FIG. 4B.

FIG. 4A is a flowchart 400A that illustrates an exemplary method for generating the network graph 112, in accordance with an embodiment of the disclosure. FIG. 4 is explained in conjunction with elements from FIG. 1, FIG. 2, FIG. 3A and FIG. 3B. The operations of the exemplary method may be executed by any computing system, for example, by the system 102 of the FIG. 1 or the processor 202 of the FIG. 2. The operations of the flowchart 400 may start at 402.

At 402, a plurality of subset matrices is determined for a plurality of time instants within the predefined time period based on the OD matrix 110. In an example, the processor 202 is configured to determine a subset matrix for a time instant within the predefined time period. In an example, the subset matrix may include traffic volume values for the geographical area during the time instant. For example, the OD matrix 110 is associated with the predefined time period, say 9:00 AM to 10:00 PM. Further, the plurality of subset matrices may be determined from the OD matrix 110 for the time instants or time intervals shorter than the time period. These time intervals may be, for example, 9:00 AM to 9:30 AM, 9:30 AM to 10:00 AM, 10:00 AM to 10:30 AM, and so forth. Moreover, the subset matrix for each of the time instants may be determined from the OD matrix 110 or based on databases supplying data for generating the OD matrix 110.

At 404, a plurality of network graphs is generated for each of the plurality of time instants based on the corresponding plurality of subset matrices. For example, the processor 202 is configured to utilize the traffic volume data from the subset matrices to determine the connectivity between various nodes (representing locations within the city) and establish the edges (connections) between them. For example, the plurality of network graphs may have same or similar nodes indicating various origin and destination locations or zones. Further, the edges of the plurality of network graphs may have different weight values. For example, the traffic volume values, or trip volume may keep on changing over time. Subsequently, the weight values of the edges of plurality of network graphs may vary across the different time instants, for example, slightly or significantly. The weight values are indicative of a time instant trip volume, providing insights into the intensity of travel flow between various locations at that specific time instant. By generating multiple network graphs 112 corresponding to different time instants, the processor 202 captures the temporal variations in travel patterns and traffic flows within the geographical area in greater detail.

At 406, the network graph 112 for the predefined time period is generated based on an aggregation of the plurality of network graphs for each of the plurality of time instants. In an example, the processor 202 is configured to consolidate the plurality of network graphs generated for each of the plurality of time instant into the single network graph 112 for the entire predefined time period. The aggregation of the plurality of network graphs for each of the plurality of time instants provides a unified view of the transportation network's structure and dynamics over the entire duration of the time period. It enables analysis of long-term trends, identification of recurring patterns, and assessment of network performance.

FIG. 4B illustrates an example network graph 400B for determining one or more critical edges, in accordance with an example embodiment of the present disclosure. The system 102 may be configured to generate the network graph 400 representing transportation infrastructure within the geographical area, such as a city.

The network graph 400B includes nodes (depicted as a node 408, a node 410, a node 412, a node 414, a node 416, a node 418, and a node 420). The network graph 400B may also include edges (depicted as an edge 422A, an edge 422B, an edge 422C, an edge 422D, an edge 422E, an edge 422F, an edge 422G, and an edge 404H, and collectively referred to as edges 422). Further, the weight value of each of the edges 422 is based on the traffic volume values in the OD matrix 300 or the generalized OD matrix 310.

In an illustrative example, the geographical area includes various zones, including an origin zone, multiple intermediate zones, and multiple destination zones. The origin zone, O, is denoted as the node 408 in the network graph 400B. Further, the intermediate zones, D₁, . . . , D_{K}, . . . , D_{N}, are denoted as the node 410, the node 412, and the node 414, respectively. Moreover, the multiple destination zones, DD₁, . . . , DD_{K}, . . . , DD_{N}, are denoted as the node. 416, the node 418, and the node 420, respectively.

In an example, each of the edges 422 of the network graph 400B has an assigned weight indicating a probability distribution of traffic volume between various travel paths, link segments and/or routes between the origin zone, the intermediate zones, and the destination zones. For instance, a weight of the edge 422A is 0.3, a weight of the edge 422B is 0.6 and a weight of the edge 422C is 0.2. Such weights may indicate that from a total number of trips originating from the origin zone, O, i.e., the node 408, 30% of the trips are headed towards the destination zone, D₁, 60% of the trips are headed towards the destination zone, D_{K}, and rest 20% of the trips are headed towards the destination zone, DN. Further, the weight of the edge 422D is 0.2, a weight of the edge 422E is 0.8, a weight of the edge 422F is 1.0, a weight of the edge 422G is 0.9, and a weight of the edge 422H is 0.1. Such weights may indicate that amongst a total number of trips arriving at the intermediate zone, D₁, 20% of them are travelling towards the destination zone, DD₁, while rest 80% are travelling towards the destination zone, DD₂. Similarly, a total number of trips or all the traffic arriving at the intermediate zone, D_{K}, travels to the destination zone, DD₂; and amongst a total number of trips arriving at the intermediate zone, DN, 90% of them are travelling towards the destination zone, DD₂, while rest 10% are travelling towards the destination zone, DD_{N}.

Based on the probability distributions indicated by the weight values of the edges 422 of the network graph 400B, the processor 202 is configured to determine the top K routes that surpass a predefined traffic volume threshold. This entails identifying the routes with the highest traffic volume values, prioritizing those that exceed the predefined threshold.

In an example, a maximum trip flow graph (MTFG) is derived from the network graph 400B, capturing the most significant travel patterns and routes within the transportation network. In this regard, the MTFG primarily focuses on connections between the origin zone, O, the intermediate zones, D₁, . . . , D_{K}, . . . , D_{N}, and the destination zones, DD₁, . . . , DD_{K}, . . . , DD_{N}. In an example, the MTFG is stored as an m×m matrix, where each node of the MTFG represents a zone or a location within the geographical area. The MTFG matrix may include total journey time (JT) information from one node to another, considering all possible drivable paths connecting them. Additionally, the MTFG matrix may include trip cost for a trip from the origin zone, O, to any of the destination zones. The trip cost may be computed as a sum of edge/arc costs incurred while traversing from the node 408 corresponding to the origin zone to a destination node. These costs are derived from both the percentage count values and the actual trip count values previously computed during the analysis of the transportation network based on historical data. For example, the cost may be associated with travel time.

Moreover, the MTFG matrix includes a standard deviation (SD) that indicates a variability or dispersion of journey times between nodes. For example, a lower SD suggests higher travel time reliability, signifying consistent and predictable travel durations. To this end, based on the network graph 400B and/or the MTFG derived from the network graph 400B, the critical edges are identified. These critical edges may indicate critical travel paths, link segments, routes, or corridors having high traffic flow and potentially high traffic congestion. The identified critical edges or the critical travel paths, link segments, routes, or corridors may be used for planning and routing, as it enables stakeholders to gauge the reliability of transportation routes and make informed decisions regarding route selection and scheduling. A manner in which critical edges may be used for route prediction is described in detail in conjunction with, for example, FIG. 5.

The MTFG matrix may be used for improved transportation infrastructure planning within the geographical area. By analyzing the MTFG matrix, critical zones and corridors can be identified, allowing transportation planners to prioritize infrastructure investments and implement targeted interventions to alleviate congestion and enhance traffic flow. Additionally, retailers and advertisers can leverage this information to strategically position themselves and target areas with high traffic volume values and potential customer footfall.

Furthermore, the MTFG matrix can be utilized for real-time monitoring of changes in the transportation network. By maintaining the generalized OD-matrix 310 containing only the nodes of the MTFG, stakeholders can track fluctuations in travel patterns and traffic flows over time. This real-time monitoring capability enables initiative-taking decision-making and facilitates timely interventions to address emerging transportation challenges and ensure the efficiency and reliability of the city's transportation network. Overall, the MTFG matrix serves as a versatile tool for transportation management and urban planning, offering valuable insights for optimizing mobility and enhancing the overall quality of life for city residents.

FIG. 5 illustrates a flowchart 500 of a method for generating navigation instructions, in accordance with an embodiment of the present disclosure. FIG. 5 is explained in conjunction with elements from FIG. 1, FIG. 2, FIG. 3A, FIG. 3B, FIG. 4A and FIG. 4B. The operations of the exemplary method may be executed by any computing system, for example, by the system 102 of the FIG. 1 or the processor 202 of the FIG. 2.

At 502, a source location and a destination location associated with navigation of a vehicle is received. In an example, the processor 202 is configured to receive the source location and the destination location associated with the navigation of the vehicle. This allows the processor 202 to receive and process information regarding a starting point and an intended destination of the vehicle's journey, enabling it to generate tailored navigation instructions and route guidance.

At 504, a pair of nodes from the plurality of nodes of the network graph 112 corresponding to the source location and the destination location is identified. In an example, the processor 202 is configured to identify the pair of nodes from the plurality of nodes of the network graph 112. By referencing the network graph 112, which encapsulates the entire transportation infrastructure, the processor 202 may pinpoint the specific nodes representing, including or being associated with the source location and the destination location.

In an example, the pair of nodes corresponding to the source location and the destination location may be connected through a single edge in the network graph 112. In such a case, the edge may form a travel route for completing the vehicle's journey. In another example, the pair of nodes corresponding to the source location and the destination location may be connected via one or more intermediate nodes and multiple edges in the network graph 112. In such a case, a summation of travel paths corresponding to the multiple edges may form the travel route for completing the vehicle's journey. To this end, the edge(s) for connecting the pair of nodes are determined based on at least one criterion, such as shortest connection or shortest path, fastest path, etc.

At 506, a determination is made to check whether at least one edge between the pair of nodes includes one of the one or more critical edges. In an example, the processor 202 is configured to determine whether a single edge or multiple edges between the pair of nodes corresponding to the source location and the destination location include any one of the identified critical edges. As may be understood, inclusion of any of the critical edges, i.e., travel path with heavy traffic flow, in the travel route may indicate longer travel time due to encountering heavy traffic and potentially congestion.

At 508, if the edge(s) corresponding to the travel route for the vehicle's journey does not include any of the critical edges, then navigation instructions are generated based on the identified edge(s).

However, if the edge(s) corresponding to the travel route for the vehicle's journey include any of the critical edges, at 510, navigation instructions are generated based on alternative edge for one of the one or more critical edges in the identified edge(s). In an example, the processor 202 is configured to generate the navigation instructions for the vehicle travelling from the source location to the destination location during the predefined time period. To this end, if a shortest path between the pair of nodes corresponding to the source location to the destination location includes any of the identified critical edges, then the processor 202 may re-evaluate a travel path. In this regard, the processor 202 may identify alternative edge(s) that may be alternative to the critical edge(s) that may be a part of the travel route. Subsequently, an updated travel route is generated, and the navigation instructions are generated based on the updated travel route.

It may be noted that while selecting the alternative edge(s) for generating the updated travel route, travel times for each of the alternative edge(s) and the critical edge(s) that may be a part of the travel route are analyzed to ensure a balance between distance and time of travel for the vehicle's journey.

FIG. 6 is a flowchart 600 that illustrates an exemplary method for determining one or more critical edges, in accordance with an embodiment of the disclosure. FIG. 6 is explained in conjunction with elements from FIG. 1, FIG. 2, FIG. 3A, FIG. 3B, FIG. 4A, FIG. 4B and FIG. 5. The operations of the exemplary method may be executed by any computing system, for example, by the system 102 of the FIG. 1 or the processor 202 of the FIG. 2.

At 602, the OD matrix 110 is obtained. The OD matrix 110 may include traffic volume values for various OD pairs within a geographical area, such as a community, a city, a state, etc. In an example, the OD matrix may correspond to the predefined time period, such as a day, a time window in a particular day, a time window for a number of days, etc.

At 604, one or more OD pairs from the plurality of OD pairs having traffic volume values greater than a traffic threshold are identified. In an example, the processor 202 identifies the one or more OD pairs characterized by significant traffic volume values, pinpointing areas of heightened transportation demand within the geographical area.

At 606, a network graph 112 is generated for the predefined time period based on the identified one or more OD pairs. In an example, the network graph is a MTFG indicating OD pairs having high traffic flow. For example, the network graph 112 is generated based on the subset 306 of the OD matrix 110 such that destinations, D₁ to D_{K} having high traffic flow are identified in the network graph 112. The network graph 112 comprises a plurality of nodes and a plurality of edges. The plurality of nodes is associated with a plurality of locations within the geographical area, and each of the plurality of edges is associated with a weight value indicative a trip volume. For example, each node within the network graph 112 corresponds to a specific location, such as an intersection, a landmark, or a point of interest, within the geographical area. Meanwhile, the edges denote connections between two nodes indicating a travel path between the nodes.

At 608, one or more critical edges are identified within the network graph 112 for the predefined time period. In an example, the processor 202 is configured to analyze the weight values associated with each edge. The processor 202 discerns the one or more critical edges representing connection between the two nodes and having high traffic volume values. The critical edges guide in decision making process on addressing congestion, optimizing infrastructure, and enhancing mobility.

At 610, edge data associated with the one or more identified critical edges for the predefined time period are stored within the map database 114. The processor 202 may be configured to store information associated with the critical edges, such as corresponding nodes or their respective origin-destination pairs, weight values indicative of trip volume, and other pertinent attributes. By storing this edge data in a structured and accessible format, the processor 202 ensures the availability of comprehensive and reliable information for subsequent analyses and decision-making processes.

Accordingly, blocks of the flowcharts 400A, 500 and 600 support-combinations of means for performing the specified functions and combinations of operations for performing the specified functions. It will also be understood that one or more blocks of the flowcharts 400A, 500 and 600, and combinations of blocks in the flowcharts 400A, 500 and 600 can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

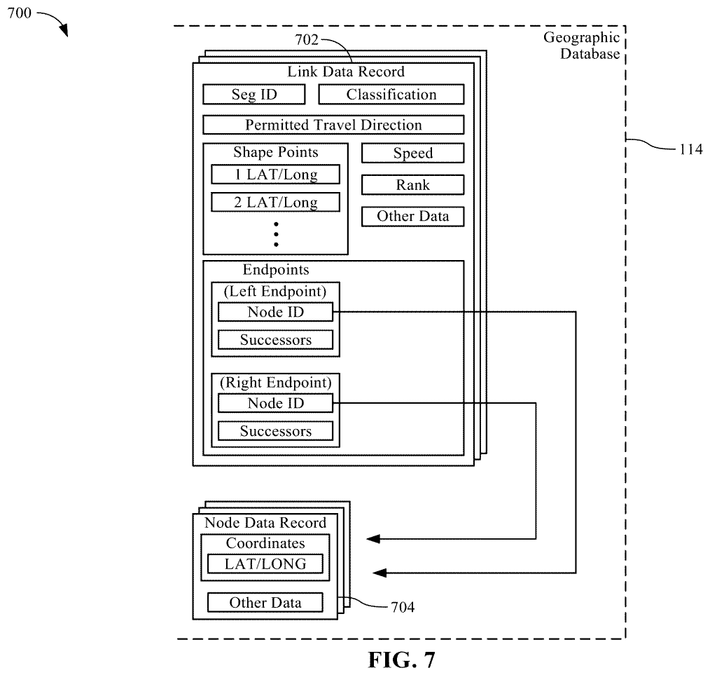

FIG. 7 shows an exemplary format of map data 700 stored in the map database 114 according to one or more example embodiments. FIG. 7 shows a link data record 702 that may be used to store data about one or more lane markings related to intersection connected links stored in the map database 114. The link data record 702 has information (such as “attributes”, “fields”, etc.) associated with it that allows identification of an intersection associated with a link and/or the geographic positions (e.g., the latitude and longitude coordinates and/or altitude or elevation) of two intersections. In addition, the link data record 702 may have information (e.g., more “attributes”, “fields”, etc.) associated with it that specify a permitted speed of travel on a portion of the road represented by the link record, a direction of travel permitted on the road portion represented by the link record, what, if any, turn restrictions exist at each of the intersections which correspond to intersections at the ends of a road portion or link represented by the link record, the street address ranges of the roadway portion represented by the link record, the name of the road, and so on. The various attributes associated with a link may be included in a single data record or are included in more than one type of records which are referenced to each other.

Each link data record that represents other-than-straight road segment may include shape point data. A shape point is a location along a link between its endpoints. To represent the shape of other-than-straight roads, the mapping platform 108 and its associated map database 114 developer selects one or more shape points along the other-than-straight road portion. Shape point data included in the link data record 702 may indicate the position, (e.g., latitude, longitude, and optionally, altitude or elevation) of the selected shape points along the represented link.

Additionally, in the compiled geographic database, such as a copy of the map database 114 that is compiled and provided to a user interface, there may also be a node data record 704 for each intersection. The node data record 704 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

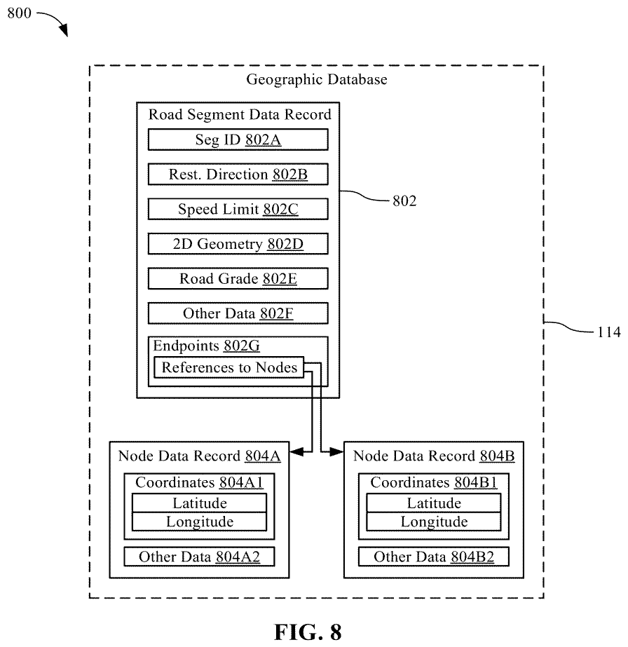

FIG. 8 shows another format of the map data 800 stored in the map database 114 according to one or more example embodiments. In the FIG. 8, the map data 800 is stored by specifying a road segment data record 802. The road segment data record 802 is configured to represent data that represents a road network. In FIG. 8, the map database 114 contains at least one road segment data record 802 (also referred to as “entity” or “entry”) for each road segment in a geographical area or region.

The map database 114 that represents a geographical area also includes a node database record (depicted as, a node data record 804A and a node data record 804B) (or “entity” or “entry”) for each intersection associated with the at least one road segment shown by the road segment data record 802. (The terms “intersection” and “segments” represent only one terminology for describing these physical geographic features and other terminology for describing these features is intended to be encompassed within the scope of these concepts). Each of the node data records 804A and 804B may have associated information (such as “attributes”, “fields”, etc.) that allows identification of the road segment(s) that connect to it and/or its geographic position (e.g., its latitude and longitude coordinates).

FIG. 8 shows some of the components of the road segment data record 802 contained in the map database 114. The road segment data record 802 includes a segment ID 802A by which the data record can be identified in the map database 114. Each road segment data record 802 has associated with it information (such as “attributes”, “fields”, etc.) that describes features of the represented road segment. The road segment data record 802 may include data 802B that indicate the restrictions, if any, on the direction of vehicular travel permitted on the represented road segment. The road segment data record 802 includes data 802C that indicates a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day. The static speed limit is the sign posted explicit speed limit for the road segment, or the non-sign posted implicit general speed limit based on legislation.

The road segment data record 802 may also include data 802D indicating the two-dimensional (“2D”) geometry or shape of the road segment. If a road segment is straight, its shape can be represented by identifying its endpoints or intersections. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 802 also includes road grade data 802E that indicate the grade or slope of the road segment. In one embodiment, the road grade data 802E includes road grade change points and a corresponding percentage of grade change. Additionally, the road grade data 802E may include the corresponding percentage of grade change for both directions of a bi-directional road segment. The location of the road grade change point is represented as a position along the road segment, such as thirty feet from the end or intersection of the road segment. For example, the road segment may have an initial road grade associated with its beginning intersection. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 802E includes the road grade change points and an actual road grade value for the portion of the road segment after the road grade change point until the next road grade change point or end intersection. In a further embodiment, the road grade data 802E includes elevation data at the road grade change points and intersections. In an alternative embodiment, the road grade data 802E is an elevation model which may be used to determine the slope of the road segment.

The road segment data record 802 also includes data 802G providing the geographic coordinates (e.g., the latitude and longitude) of the end points of the represented road segment. In one embodiment, the data 802G are references to the node data records 804 that represent the intersection corresponding to the end points of the represented road segment.

The road segment data record 802 may also include or be associated with other data 802F that refer to various other attributes of the represented road segment. The various attributes associated with a road segment may be included in a single road segment record or may be included in more than one type of record which cross-reference each other. For example, the road segment data record 802 may include data identifying the name or names by which the represented road segment is known, the street address ranges along the represented road segment, and so on.

FIG. 8 also shows some of the components of the node data record 804A and 804B contained in the map database 114. Each of the node data records 804A and 804B may have associated information (such as “attributes”, “fields”, etc.) that allows identification of the road segment(s) that connect to it and/or its geographic position (e.g., its latitude and longitude coordinates). For the embodiment shown in FIG. 8, the node data records 804A and 804B include the latitude and longitude coordinates 804A1 and 804B1 for corresponding intersection. The node data records 804A and 804B may also include other data 804A2 and 804B2 that refer to various other attributes of the intersections. In some embodiments, the node data records 804A and 804B may be associated with at least one first point and at least one second point, which may be border points of a feature line or lane marking and at least one second line in vicinity of the feature line (or at least one first point) respectively.

Thus, the overall data stored in the map database 114 may be organized in the form of different layers for greater detail, clarity and precision. Specifically, in the case of high-definition maps, the map data may be organized, stored, sorted, and accessed in the form of three or more layers. These layers may include road level layer, lane level layer and localization layer. The data stored in the map database 114 in the formats shown in FIG. 7 and FIG. 8 may be combined in a suitable manner to provide these three or more layers of information. In some embodiments, there may be lesser or fewer number of layers of data also possible, without deviating from the scope of the present disclosure.

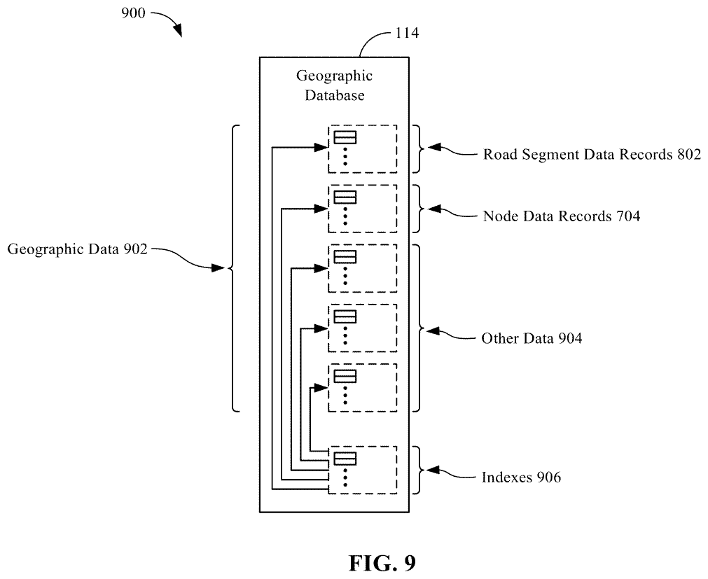

FIG. 9 illustrates a block diagram 900 of the map database 114 storing map data or geographic data 902 in the form of road segments/links, intersections, and one or more associated attributes as discussed above. Furthermore, attributes may refer to features or data layers associated with the link-intersection database, such as an HD lane data layer.

In addition, the map data 902 may also include other kinds of data 904. The other kinds of data 904 may represent other kinds of geographic features or anything else. The other kinds of data 904 may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 114 also includes indexes 906. Indices 906 may include several types of indexes that relate the diverse types of data to each other or that relate to other aspects of the data contained in the geographic database 114.

The data stored in the map database 114 in the various formats discussed above may help in providing precise data for high-definition mapping applications, autonomous vehicle navigation and guidance, cruise control using ADAS, direction control using accurate vehicle maneuvering and other such services. In some embodiments, the system 102 accesses the map database 114 storing data in the form of various layers and formats depicted in FIGS. 7-9, to retrieve map data or information from the map database 114. The system 102 may retrieve sensor data, traffic-related information and other information relating to road segments and link topology and geometry.

Returning to FIG. 1, the communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof It is contemplated that the data network may be any local area network (LAN), metropolitan area network (MAN), wide area network (WAN), a public data network (e.g. the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g. Worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In an example, the system 102 may be embodied as a cloud-based service, a cloud-based application, a cloud-based platform, a remote server-based service, a remote server-based application, a remote server-based platform, or a virtual computing system. In another example, the system 102 may be an OEM (Original Equipment Manufacturer) cloud. The OEM cloud may be configured to anonymize any data received by the system 102, before using the data for further processing, such as before sending the data to database 106. In an example, anonymization of the data may be done by the mapping platform 108.

The mapping platform 108 may comprise suitable logic, circuitry, and interfaces that may be configured to store and process information. The mapping platform 108 may also be configured to store and update data within the map database 114. The mapping platform 108 may include or may be configured to perform techniques related to, but not limited to, geocoding. routing (multimodal, intermodal, and unimodal), clustering algorithms, machine learning in Location based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as, chips) that includes materials, components and/or wires on a structural assembly (such as, a baseboard).

In some example embodiments, the mapping platform 108 may include the processing server 116 for conducting the processing functions associated with the mapping platform 108 and the map database 114 for storing map data and other information. In an example, the map database 114 may store information relating to geographical areas. In an embodiment, the processing server 116 may comprise one or more processors configured to process requests received from the system 102. The processors may fetch data from the map database 114 and transmit the same to the system 102 in a format suitable for use by the system 102. The critical edges may be collected from any sensor or database that may inform the mapping platform 108 or the map database 114. For example, motion sensors, inertia sensors, image capture sensors, proximity sensors, LIDAR (light detection and ranging) sensors, and ultrasonic sensors may be used to collect the plurality of OD pairs. In some example embodiments, as disclosed in conjunction with the various embodiments disclosed herein, the system 102 may be used to process the plurality of OD pairs for determining the plurality of critical edges within the geographical area.

In some example embodiments, the map database 114 may also be configured to receive, store, and transmit other sensor data and probe data including positional, speed, and temporal data received from vehicles. In accordance with an embodiment, the probe data may include, but is not limited to, real time speed (or individual probe speed), incident data, geolocation data, timestamp data, and historical pattern data.

The map database 114 may further be configured to store object-related data and topology and geometry-related data for a route network and/or road network as map data. The map data may also include cartographic data, routing data, and maneuvering data. For example, the data stored in the map database 114 may be compiled (such as into a platform specification format (PSF)) to organize and/or processed for determining the critical edges. The compilation to produce the end user databases may be performed by a party or entity separate from the map developer. For example, a customer of the map developer, such as a navigation device developer or other end user device developer, may perform compilation on a received database in a delivery format to produce one or more compiled navigation databases.

The system 102 may comprise a database 106 component, which serves as a repository for storing and managing various types of data relevant to transportation planning and management. The database 106 may store diverse datasets, such as origin-destination matrices, network graph 112, historical traffic data, critical routes information, and stability scores. By leveraging the database 106, the system 102 may efficiently organize, retrieve, and analyze large volumes of transportation-related data. Additionally, the database 106 may facilitate data integration and sharing across different modules or components of the system 102, enabling seamless operation and enhancing overall system performance and effectiveness.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer executable instructions; and
one or more processors configured to execute the instructions to:
obtain an origin-destination (OD) matrix of a predefined time period indicating a plurality of traffic volume values for a plurality of OD pairs in a geographical area;
identify one or more OD pairs of the plurality of OD pairs having traffic volume values greater than a traffic threshold;
generate a network graph for the predefined time period based on the identified one or more OD pairs, the network graph comprising a plurality of nodes and a plurality of edges, wherein the plurality of nodes is associated with a plurality of locations within the geographical area, and wherein each of the plurality of edges is associated with a weight value indicative a trip volume;
determine one or more critical edges of the plurality of edges for the predefined time period based on the weight value of each of the plurality of edges; and
store edge data associated with the one or more critical edges for the predefined time period in a map database.

2. The system of claim 1, wherein each of the plurality of edges indicates a travel path between a corresponding pair of nodes from the plurality of nodes, and wherein the one or more critical edges correspond to one or more travel paths having the weight value greater than a weight threshold during the predefined time period.

3. The system of claim 2, wherein the one or more processors are further configured to:
determine an average travel time for each of the one or more travel paths associated with the plurality of edges for the predefined time period; and
store the average travel time in association with the corresponding weight value for each of the plurality of edges.

4. The system of claim 1, wherein the one or more processors are further configured to:
determine a plurality of subset matrices for a plurality of time instants within the predefined time period based on the OD matrix;
generate a plurality of network graphs for each of the plurality of time instants based on the corresponding plurality of subset matrices, wherein each of the plurality of network graphs comprise the plurality of nodes and one or more edges, and wherein each of the one or more edges have an associated weight indicative of a time instant trip volume; and
generate the network graph for the predefined time period based on an aggregation of the plurality of network graphs for each of the plurality of time instants.

5. The system of claim 1, wherein the one or more processors are further configured to:
generate a tree graph for the predefined time period based on the plurality of nodes and an inverse of the weight value of each of the plurality of edges; and
determine the one or more critical edges of the plurality of edges for the predefined time period based on the tree graph.

6. The system of claim 5, wherein the one or more processors are further configured to:
generate a plurality of historical network graphs, wherein each of the plurality of historical network graphs correspond to historical periods of time associated with the predefined time period;
generate a plurality of historical tree graphs corresponding to each of the plurality of historical network graphs;
compare the tree graph and the plurality of historical tree graphs to determine a stability score; and
generate a trip flow pattern graph for the geographical area based on the tree graph and the plurality of historical tree graphs on ascertaining the stability score to be greater than a stability threshold.

7. The system of claim 5, wherein the tree graph is a minimum spanning tree graph.

8. The system of claim 1, wherein the one or more processors are further configured to:
generate navigation instructions for a vehicle associated with the geographical area based on the one or more critical edges for the predefined time period.

9. The system of claim 8, wherein one or more processors are further configured to:
receive a source location and a destination location associated with navigation of the vehicle;
identify a pair of nodes from the plurality of nodes of the network graph corresponding to the source location and the destination location;
determine whether at least one edge between the pair of nodes includes one of the one or more critical edges; and
generate the navigation instructions based on the determination, wherein the navigation instructions include an alternative edge for one of the one or more critical edges in the at least one edge.

10. The system of claim 1, wherein the network graph is a maximum trip flow graph (MTFG).

11. A method comprising:
obtaining an origin-destination (OD) matrix of a predefined time period indicating a plurality of traffic volume values for a plurality of OD pairs in a geographical area;
identifying one or more OD pairs of the plurality of OD pairs having traffic volume values greater than a traffic threshold;
generating a network graph for the predefined time period based on the identified one or more OD pairs, the network graph comprising a plurality of nodes and a plurality of edges, wherein the plurality of nodes is associated with a plurality of locations within the geographical area, and wherein each of the plurality of edges is associated with a weight value indicative a trip volume;
determining one or more critical edges of the plurality of edges for the predefined time period based on the weight value of each of the plurality of edges; and
storing edge data associated with the one or more critical edges for the predefined time period in a map database.

12. The method of claim 11, wherein each of the plurality of edges indicates a travel path between a corresponding pair of nodes from the plurality of nodes, and wherein the one or more critical edges correspond to one or more travel paths having the weight value greater than a weight threshold during the predefined time period.

13. The method of claim 12, further comprising:
determining an average travel time for each of the one or more travel paths associated with the plurality of edges for the predefined time period; and
storing the average travel time in association with the corresponding weight value for each of the plurality of edges.

14. The method of claim 11, further comprising:
determining a plurality of subset matrices for a plurality of time instants within the predefined time period based on the OD matrix;
generating a plurality of network graphs for each of the plurality of time instants based on the corresponding plurality of subset matrices, wherein each of the plurality of network graphs comprise the plurality of nodes and one or more edges, and wherein each of the one or more edges have an associated weight indicative of a time instant trip volume; and
generating the network graph for the predefined time period based on an aggregation of the plurality of network graphs for each of the plurality of time instants.

15. The method of claim 11, further comprising:
generating a tree graph for the predefined time period based on the plurality of nodes and an inverse of the weight value of each of the plurality of edges; and
determining the one or more critical edges of the plurality of edges for the predefined time period based on the tree graph.

16. The method of claim 11, further comprising:
generating a plurality of historical network graphs, wherein each of the plurality of historical network graphs correspond to historical periods of time associated with the predefined time period;
generating a plurality of historical tree graphs corresponding to each of the plurality of historical network graphs;
comparing the tree graph and the plurality of historical tree graphs to determine a stability score; and
generating a trip flow pattern graph for the geographical area based on the tree graph and the plurality of historical tree graphs on ascertaining the stability score to be greater than a stability threshold.

17. The method of claim 11, further comprising:
receiving a source location and a destination location associated with navigation of the vehicle;
identifying a pair of nodes from the plurality of nodes of the network graph corresponding to the source location and the destination location;
determining whether at least one edge between the pair of nodes includes one of the one or more critical edges; and
generating navigation instructions for a vehicle associated with the geographical area based on the determination, wherein the navigation instructions include an alternative edge for one of the one or more critical edges in the at least one edge.

18. A computer programmable product comprising a non-transitory computer readable medium having stored thereon computer executable instructions, which when executed by one or more processors, cause the one or more processors to conduct operations comprising:
obtaining an origin-destination (OD) matrix of a predefined time period indicating a plurality of traffic volume values for a plurality of OD pairs in a geographical area;
identifying one or more OD pairs of the plurality of OD pairs having traffic volume values greater than a traffic threshold;
generating a network graph for the predefined time period based on the identified one or more OD pairs, the network graph comprising a plurality of nodes and a plurality of edges, wherein the plurality of nodes is associated with a plurality of locations within the geographical area, and wherein each of the plurality of edges is associated with a weight value indicative a trip volume;
determining one or more critical edges of the plurality of edges for the predefined time period based on the weight value of each of the plurality of edges; and
storing edge data associated with the one or more critical edges for the predefined time period in a map database.

19. The computer programmable product of claim 18, wherein the operations further comprise:
generating a tree graph for the predefined time period based on the plurality of nodes and an inverse of the weight value of each of the plurality of edges; and
determining the one or more critical edges of the plurality of edges for the predefined time period based on the tree graph.

20. The computer programmable product of claim 18, wherein the operations further comprise:
generating a plurality of historical network graphs, wherein each of the plurality of historical network graphs correspond to historical periods of time associated with the predefined time period;
generating a plurality of historical tree graphs corresponding to each of the plurality of historical network graphs;
comparing the tree graph and the plurality of historical tree graphs to determine a stability score; and
generating a trip flow pattern graph for the geographical area based on the tree graph and the plurality of historical tree graphs on ascertaining the stability score to be greater than a stability threshold.
